(19) United States
(12) Patent Application Publication
(10) Pub. No.: US 2010/0211605 A1
(43) Pub. Date: Aug. 19, 2010

(54) Apparatus and method for unified web-search, selective broadcasting, natural language processing utilities, analysis, synthesis, and other applications for text, images, audios and videos, initiated by one or more interactions from users

(76) Inventor: Subhankar Ray, Plano, TX (US)

Correspondence Address: Subhankar Ray, P.O. Box 251246, Plano, TX, 75025, US

(21) Appl. No.: 12/705,933

(22) Filed: Feb. 15, 2010

Related U.S. Application Data
(60) Provisional application No. 61/207,768, filed on Feb. 17, 2009.

(51) Int. Cl. G06F 17/30

(52) U.S. Cl. 707/780; 707/E17.014; 707/758

(57) ABSTRACT

Apparatus and method for unified web-search, selective broadcasting, natural language processing utilities, analysis, synthesis, and other applications for text data, image data, audio data, video data, data referenced by Universal Resource Identifier, or a combination thereof, initiated by just one required submit interaction from users with a central controller including at least one CPU and a memory operatively connected to the CPU, at least one terminal, adapted for communicating with the central controller, for transmitting to the central controller input information including text data, image data, audio data, video data, data referenced by Universal Resource Identifier, or a combination thereof, special characters to command at least another natural language processing or other utility requests in addition to web or other search,

[symbol]

### CROSS REFERENCE TO RELATED APPLICATIONS

This application is based on provisional application Ser. No. 61/207,768, filed on Feb. 17, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of web-search, machine learning and more specifically to apparatus and method for unified web-search, selective broadcasting, natural language processing utilities, analysis, synthesis, and other applications for text, images, audios and videos, initiated by one or more interactions from users.

Historically web search engines use search boxes using the input tag of html. Also web search engines only offer links to pages that contain the searched keywords.

The relatively small web-search box generated by input tag of html does not allow multi-line input of text. It is a serious limitation for searchers to express their intention by dividing their text in paragraphs, or using other text formatting techniques. It also does not allow any spelling or grammatical error corrections by the users before submitting their input to the search engine. The present web search is completely driven by keywords, and not by a chunk of texts, videos, audios, or images. The present search engines do not allow selective broadcasting, classifications, clustering, or other text-mining or natural language processing operations on the inputted content as a part of the returned results of a search process.

### BRIEF SUMMARY OF THE INVENTION

The primary object of the invention is to provide a method, apparatus, and program for unified web-search, broadcast, and natural language processing utilities, analysis, synthesis, and other applications for text, images, audios and videos.

Another object of the invention is to provide a system enabling web users to do search, natural language processing functions, analysis, synthesis, and use of other applications of text, images, audios and videos, and broadcast to multiple web sites by only one click, or one enter or one single action or multiple actions on their network connected devices.

Another object of the invention is to provide a system enabling multi-line input facility so that web searchers can express their intentions using paragraphs, special characters, formatting, style sheets, Universal Resource Identifier, and can preview it, correcting any spelling and grammatical mistakes before submitting for search and other utilities.

A further object of the invention is to provide a system enabling multi-line input facility so that web searchers can express their intentions, and in turn allows combined text, video, audio, and image based web search using both absolute reference and references via Universal Resource Locator of the text, video, audio and images.

Yet another object of the invention is to provide a system enabling a search, broadcast, analysis, synthesis server the ability to see the shifting of ideas across the text, audio, video, or image input (direct or indirect using links or Universal Resource Locator) by analyzing the paragraph demarcations, and starting of sentences of a paragraph, length of paragraphs, and analyzing different attributes of image, audio, and video files to provide various utilities and applications by understanding the input.

Still yet another object of the invention is to provide a system enabling a search, broadcast, analysis, synthesis server the ability to extract different concepts, related concepts from a chunk of text, video, audio, and image, and enable related web search for those concepts.

Another object of the invention is to provide a system enabling a search, broadcast, analysis, synthesis server the ability to synthesize different concepts, related concepts, related text, audio, images, and videos from a chunk of text, video, audio, and image, and enable related web search for those concepts.

Another object of the invention is to provide a system enabling a search, broadcast, analysis, synthesis server the ability to do statistical similarity (using Euclidean distance or different norms in the probability space) checks among multiple chunks of text, video, audio, and images and enables related web search for those multiple chunks of text, video, audio, images, and concepts.

A further object of the invention is to provide a system enabling a search, broadcast, analysis, synthesis server the ability to do machine summarization of a multiple chunk of text, videos, audios, and images and enables related web search for those chunk of the text, video, audio, and images and their summarized text, video, audio, and images.

Yet another object of the invention is to provide a system enabling a search, broadcast, analysis, synthesis server the ability to get input (directly or via Universal Resource Identifier) of a chunk or chunks of text, videos, audios, and images, and one or more questions, and enables finding of answers from the given text, videos, audios, and images and initiation of web search for the input text, videos, audios, and images, or the question or for both.

Still yet another object of the invention is to provide a system enabling a search, broadcast, analysis, synthesis server the ability to do categorization, clustering, or other methods of separation (supervised or unsupervised, or combined) of the input text, videos, audios, and images and enables related web search.

Another object of the invention is to provide a system enabling a search, broadcast, analysis, synthesis server the ability to do categorization, clustering, classification, or other methods of separation (supervised or unsupervised, or combined) of the input text, videos, audios, and images and enables related web search for the text, videos, audios, and images, and decide broadcast or not to broadcast or where to broadcast them (to different user comment publishing websites) based on the results of the categorization, clustering, classification, or other methods of separation (supervised or unsupervised, or combined).

Another object of the invention is to provide a system enabling a search, broadcast, analysis, synthesis server the ability to do parts-of-speech tagging of input text, and entity tagging of the input text, video, audio, and image and enables related web search for the text, videos, audios, and images.

A further object of the invention is to provide a system enabling a search, broadcast, analysis, synthesis server the ability to identify a text with or without, videos, audios, and images as spam email, and enables related web search for the input.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed apparatus and method for unified web-search, selective broadcasting, natural language processing utilities, analysis, synthesis, and other applications for text data, image data, audio data, video data, data referenced by Universal Resource Identifier, or a combination thereof, initiated by just one required submit interaction from users comprising: a central controller including at least one CPU and a memory operatively connected to the CPU, at least one terminal, adapted for communicating with the central controller, for transmitting to the central controller input information including text data, image data, audio data, video data, data referenced by Universal Resource Identifier, or a combination thereof, special characters to command at least another natural language processing or other utility requests in addition to web or other search,

In accordance with a preferred embodiment of the invention, there is disclosed a method for unified web-search, selective broadcasting, data-mining utilities, analysis, synthesis, and other applications for text, images, audios and videos, references to other resources via Universal Resource Identifier, or a combination thereof initiated by one or more interaction from users using at least one central controller including at least one CPU and a memory operatively connected to said CPU and containing a program adapted to be executed by said CPU, and a terminal adapted for communicating with said CPU, the method comprising the steps of: 1. Inputting texts, videos, audios, and images references to other resources via Universal Resource Identifier, or a combination thereof to the controller via the terminal, 2. Inputting analysis, synthesis, search criteria to the controller via the terminal, 3. Computing search, broadcast, summarization, similarity checking, clustering, classification, other natural language processing functions, analysis, synthesis, and use of other external applications by having the CPU execute said program, and 4. Outputting the search, analysis, synthesis, and broadcast results to the terminal.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The invention and further developments of the invention are explained in even greater detail in the following exemplary drawings. The present invention will be readily understood by the following detailed description in conjunction with the accompanying drawings, wherein like reference numerals designate like structural elements. The drawings are merely exemplary to illustrate certain features that may be used singularly or in combination with other features and the present invention should not be limited to the embodiments shown.

FIG. 1 is a block diagram of an illustrative information retrieval system in which a user input for searching information, broadcast, and other natural language processing applications may be implemented in a unified way.

FIG. 2 is a block diagram of an illustrative information retrieval system in which a search box is used to input multi-line text for better information retrieval and broadcasting according to the present invention.

FIG. 3 shows interactions among a Web Browser and Search, Broadcasting, Natural Language Processing server and a number of other Web servers within a computer network such as the Internet, according to an embodiment of the invention.

FIG. 4 is a schematic diagram of the client and server computers according to the present invention.

FIGS. 5a and 5b are a block diagram of a system level operation illustrating a functional or client level operation of a user terminal with the Search, Broadcast, and Natural Language Processing Server across a data network according to an embodiment of the invention.

FIG. 6 illustrates a bigger scrollable two dimensional (2D) search box for entering multi-line text, multi-media according to an embodiment of the invention.

FIGS. 7a and 7b illustrate one embodiment of a flowchart of operations illustrating an exemplary process for performing information retrieval by the search engine, Natural Language, Multi-Media Processing and information broadcasting using the system of FIGS. 5a and 5b.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Systems and methods that use a multi-line search box with higher height using textarea html tag or other tags instead of the usual html input tag, used for user input to the web search engine for improved unified search and natural language processing functionalities that include selective broadcasting of the user input. The improved functionality is a unification of search (information retrieval) with broadcast and other natural language processing of the multi-media user input to the search engine.

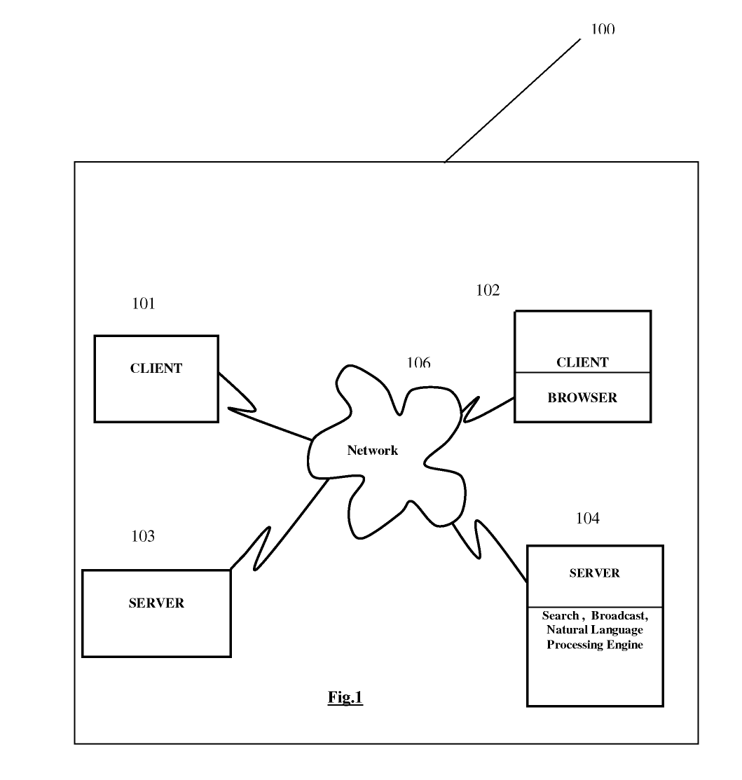

FIG. 1 is a block diagram of an illustrative information retrieval system 100 in which a multi-line search box is used to input paragraphs or chunks of text data, image data, audio data, video data, referenced by Universal Resource Identifier, or a combination thereof, initiated by just one required submit interaction from users, in multiple lines for better information retrieval and broadcast. The system 100 may include multiple client devices 101,102 that are connected to multiple servers 103, 104 via a network 106. The client devices may include a browser as in 102 for accepting user input and for displaying information that has been received from other systems 101, 103, 104 over the network 106. The servers may include a search, broadcasting, and other natural language processing engine as in 104 for accepting user queries transmitted over the network 106, as it does searching to display results, natural language processing, broadcasting to different public posting sites. The network 106 may comprise a local area network (LAN), a wide area network (WAN), a virtual private network (VPN), a telephone network, such as the Public Switched Telephone Network (PSTN), an intranet, the Internet, or a combination of networks. The illustration 100 is merely shown as an illustration in FIG. 1 that includes two client devices 101,102 and two servers 103 and 104 connected via the network 106. However, it will be appreciated that in practice there may be more or fewer client devices, servers and/or networks, and that some client devices may also perform at least some functions of a server and some servers may also perform at least some functions of a client.

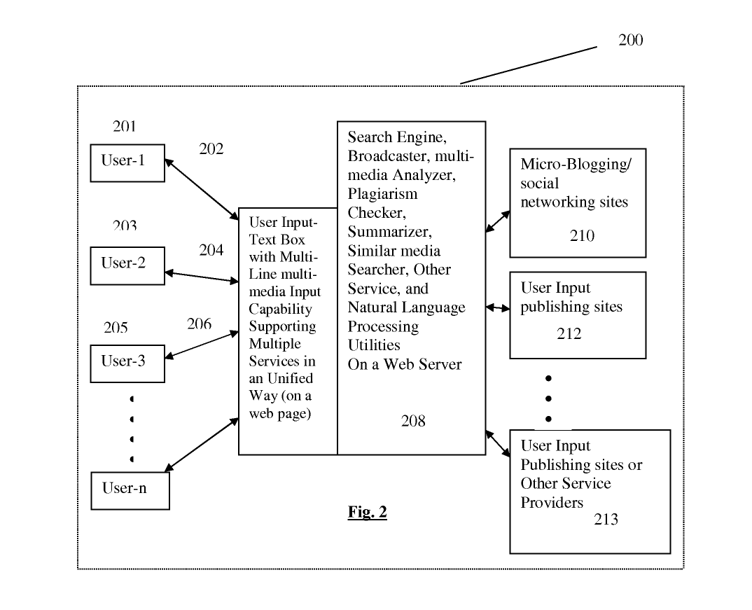

FIG. 2 is a block diagram of an illustrative information retrieval system 200 in which a number of users 201, 203, 205 having a mechanism to access the search engine software in the server over the internet 202, 204, 206 with inputs in the multi-line search box of the search engine 208 of the present invention for entering text data, image data, audio data, video data, data referenced by Universal Resource Identifier, or a combination thereof, initiated by just one required submit interaction from users for different utility performances that include among others (i) searching (ii) micro blogging, broadcasting to different social networking sites 210 (iii) input to different user content publishing sites 212 (iv) multi-media Analyzer (v) Plagiarism Checker, (vi) Summarizer, (vii) Similar content, media Searcher (viii) Parts-of-Speech and entity tagger (ix) Other Services, Utilities and Natural Language processing utilities. The search engine is a search, analysis, synthesis, natural language processing, and broadcasting software for inputted text data, image data, audio data, video data, data referenced by Universal Resource Identifier, or a combination thereof.

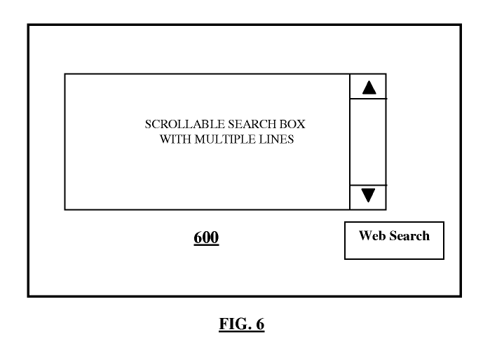

In the exemplary embodiment of FIG. 2, user 201 enters a multi-line text in the text box of the search engine 208. An example of the search box is provided in the FIG. 6. By appending ‘t?’ in front of the text, user 201 can instruct the search engine to not only search for the input text, but also to broadcast the input to micro-blogging, social-networking sites like 210, 212 and 213. If there is any Universal Resource Identifier in the text, the search engine 208 fetches those resources. Those resources could be audio data, video data and image data.

Before broadcasting, the search engine 208 performs different clustering and classifying analysis on the text data, audio data, video data and image data, different paragraph breaks in the text, starting sentence of the input, in order to determine which the appropriate sites for the inputted content are. It also synthesizes a summary of the content in case the content is too long for some publishing sites 210 or 212. It further determines what kind of account it will use to post certain content to certain user input publishing sites. For example, content about politics or sports may be posted under an account called politcs101 and sports101 respectively, so that other users following the account in the user-input-publishing site 210 or 212 enjoy more related content. Using this process the user 201 can broadcast his/her input in an anonymous or non-anonymous way. The process returns not only the search results to the user 201 based on the input text, but also the results of the broadcasting, categorization, and summarization of the input.

The related search process takes into consideration the paragraph structure, formatting of the inputted text like bold, underlines, other media content to understand the intent of the user 201 and to deliver relevant search results enhancing keyword based search (offered by existing search engines) to content based search.

For example, by keying in special characters ‘***’ in front of the inputted text, followed by ‘***’ user 201 can order the search engine 208 to provide search results and summarization of the inputted content. The Search engine 208 delivers accordingly.

By keying in special characters ‘***’ in front of the inputted email with header, user 201 can order the search engine 208 to provide search and simultaneous identification or classification of a text with or without, videos, audios, and images as spam email. The Search engine 208 delivers accordingly.

By adding special characters ‘***’ in front of a chunk of content followed by ‘***’ and a question, user 201 can order the search engine 208 to provide/find answers to the questions as found in the inputted content, and also to provide search results related to the inputted content and question. The search engine 208 delivers accordingly.

By adding ‘g?’ in front of the input, user 201 can order search engine 208 to provide search results and parts-of-speech (POS) and entity tagging of the inputted content. The search engine 208 delivers accordingly.

By separating two chunks of content by special characters ‘***’, user 201 can order search engine 208 to provide search results for the inputted content and Euclidean or other type of statistical distance, similarity between the inputted content. The search engine 208 delivers accordingly.

By separating two Facebook profiles or other user profiles by special characters ‘***’, user 201 can order search engine 208 to provide search results for the inputted content, Euclidean, cosine or other type of statistical distance between profiles, collaborative filtering based similarity between the inputted content. The search engine 208 delivers accordingly.

Clustering, classification, summarization, Parts-of-speech tagging, entity tagging, collaborative filtering and Euclidean or cosine, norms (in probability space) or other statistical distance methods and searching methods are not expanded here because they are part of standard algorithms in Natural Language Processing and are understood by those skilled in the art; the interfaces and development steps will not be described in detail herein.

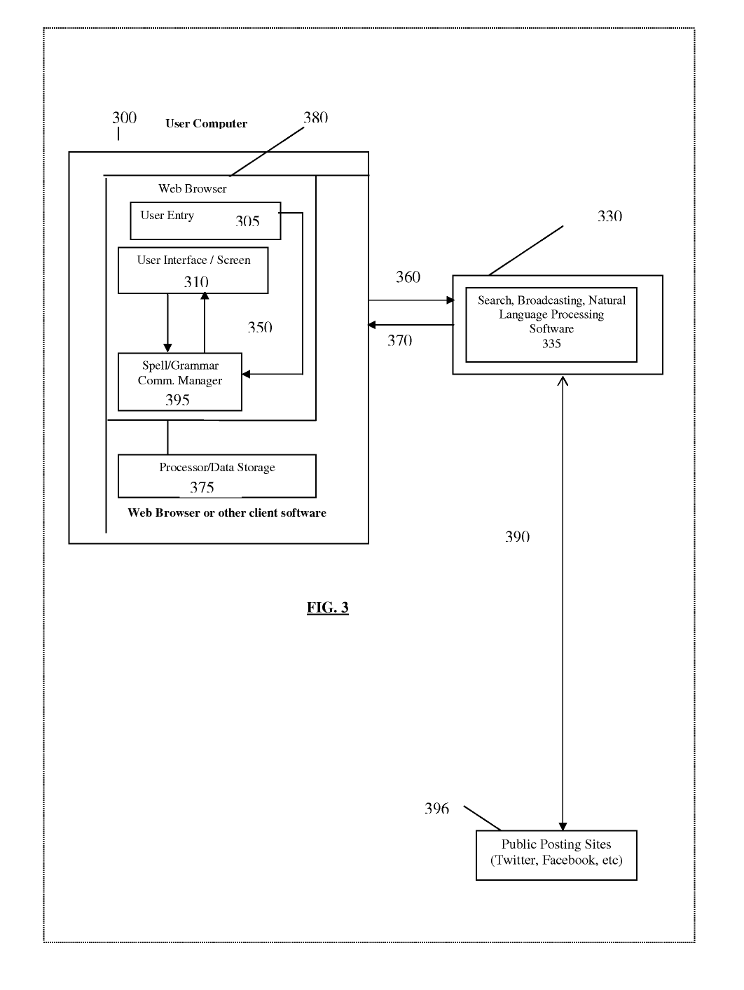

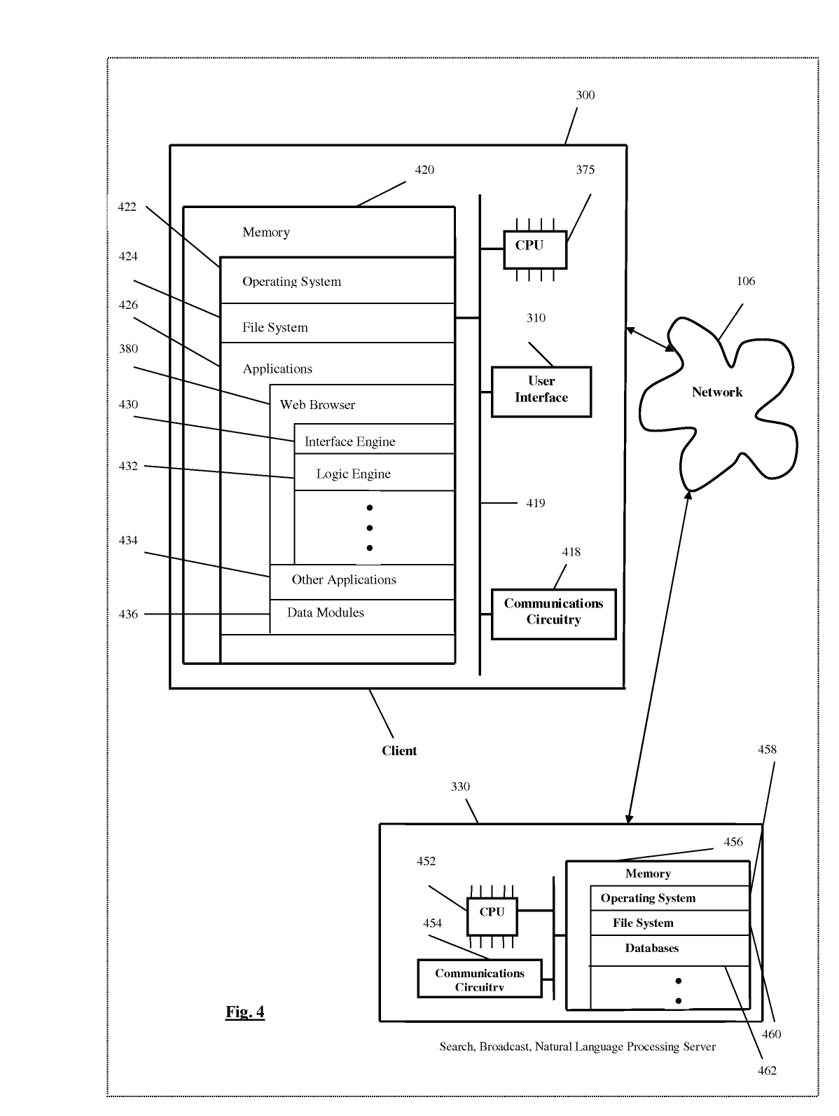

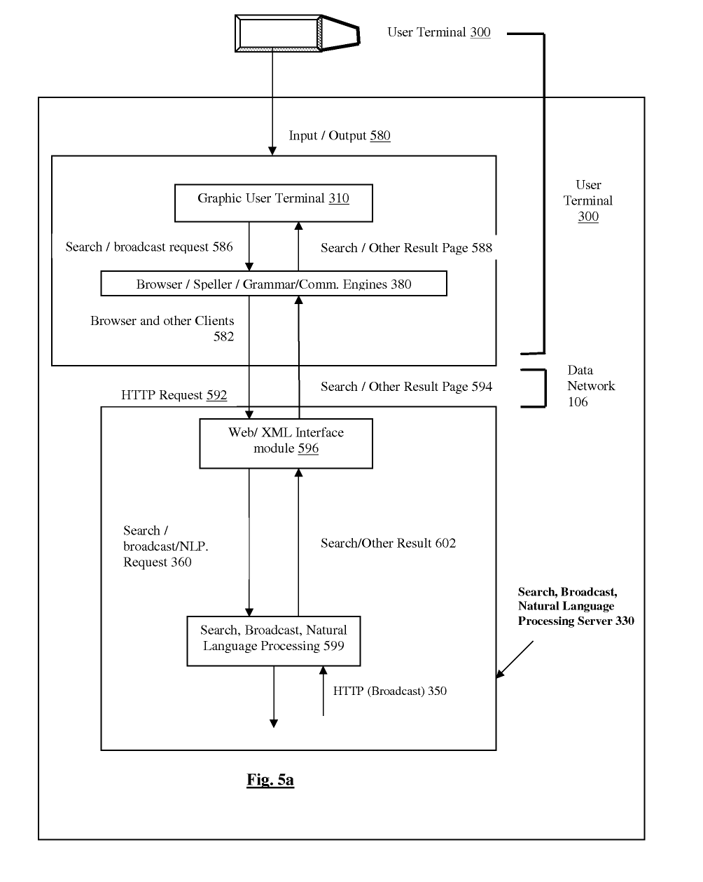

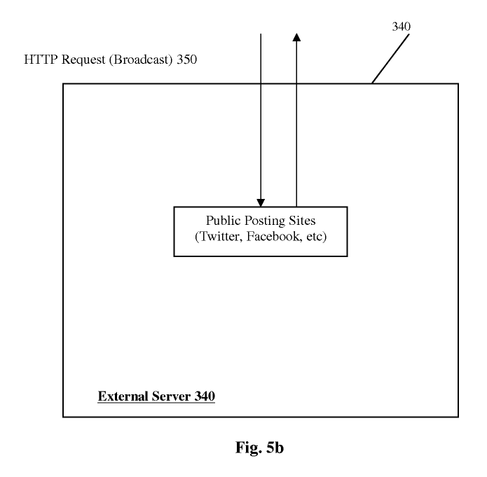

FIG. 3 shows a number of components of a data processing network, including a number of Search, Broadcasting, and Natural Language Processing Software 335 executing on server computers 330. Server 330 can be more than one computer servers doing parallel processing. The Search and Broadcast server 330 are connected with a user's computer 300 and the External user content posting Servers 396. The user's computer 300 with a central controller (processor/CPU operatively connected to storage or memory) 375 is running a Web Browser program 380 and a spell checker, grammar checker, and communication manager program 395 which interfaces with the Web Browser 380. As is known in the art, a Web Browser is with a processor 375, an application program which is capable of sending Hypertext Transfer Protocol (HTTP) requests to Search and Broadcast server to search information on the World Wide Web Internet service or broadcast to different pubic posting sites, or do both. Alternative embodiments of the present invention include browsers or other client requester programs which support the File Transfer Protocol (FTP), Lightweight Directory Access Protocol (LDAP) or other protocols for sending requests.

Each of the user computer 300 and the Search, Broadcasting, Natural Language Processing server computer 330 may be remote from each other and coupled via one or more networks. For example, user computer 300 may be coupled to Search and Broadcast server computer 330 via the Internet and accessible via the World Wide Web Internet Service, to enable user computer to request web pages. The user computer 300 and the Search and Broadcast server computer 330 could also be coupled via a local network or intranet.

The user computer 300 is not limited to a particular type of data processing apparatus, and may be a conventional desktop or lap-top personal computer, a personal digital assistant (PDA) or another specialized data processing device. The user computer 300 may connect to a network of data processing systems via wireless or hardwired connections. Similarly, the server computer 330 can be any data processing apparatuses, multiple parallel processing computers which are capable of running a Web server application, directory server or similar server program. Software-implemented elements of the embodiment described in detail below are not limited to any specific operating system or programming language.

In one embodiment of the present invention, the spell checker, grammar checker, and communication manager program 395 is implemented as a computer program which extends and modifies the functions of a standard Web browser. In particular, this embodiment provides a “plug-in” program module for connecting to a standard connection interface of IE or Firefox Web Browser program. As is known in the art, “plug-in” modules are programs that can be easily installed and used as part of a Web browser. Once installed, “plug-in” modules are recognized automatically by the Web Browser 380, and the Web Browser 380 and plug-in modules call each other's functions via simple APIs. A number of “plug-in” components are already widely available for use with Microsoft Corporation's Internet Explorer or Mozillia Firebox Web Browsers. As the interfaces and development of “plug-in” components to add functions to an existing Web Browser are understood by those skilled in the art, the interfaces and development steps will not be described in detail herein.

The spell checker, grammar checker, and communication manager program 395 cooperates with the Web Browser 380 to respond to entry of a search request within an entry field 305 of the Web Browser's user interface/screen 310. The spell and grammar checking are done via interface 350, as the user is inputting or typing in the search box even before any communication with the server 330. A search and broadcast request is sent to one or more specified Web Search and Broadcast server 330 to initiate searching for content relevant to the request. In certain embodiments of the present invention, the search request may be passed to an array of servers. Searching is performed in response to entry of search text into a Web Browser's main user entry field 305, the multi-line entry field 600 (see FIG. 6) which is used for entering text, multi-media content (direct or indirect input using links or Universal Resource Locator), Uniform Resource Locator (URL) and other Uniform Resource Identifier (URI) information. Enabling the user to enter, preview, and correct lengthy search text, multimedia directly into a generally available entry field improves the user experience by avoiding the need to shorten the search text to accommodate in the usual search box that result in limited amount of information that could be previewed in the search box.

It also allows a mechanism so that web searchers can express their intentions using paragraphs, interrogative and other grammatical moods, separating input by special characters, special words or text or letters, formatting, style sheets, and Universal Resource Identifier. Server 330 sees, extracts and understand the shifting of ideas/concepts across the formatted text (bold or underlined text or html tagged text), audio, video, or image input (direct or indirect using links or Universal Resource Locator) by analyzing the paragraph demarcations, and starting of sentences of a paragraph, length of paragraphs, and analyzing different attributes of text, image, audio, and video inputs and files to provide various utilities and applications. Bold or underline text emphasizes the portion of the text giving the server 330 more information about the intention of the user inputting the content. Starting sentence of a new paragraph indicates beginning of new concepts. Punctuations convey the grammatical moods of the sentence. Length of paragraphs, and different attributes (like size, date of creation, format of media files, quality of the source websites) of text, image, audio, and video inputs and files are available to server 330.

Server 330 uses all these enhanced information (compared to present search engines) to compute and produce better search results, better determination (depending on the clustering, classification results) of where to broadcast the content, better synthesis of the summary of the content, do better clustering, classification, supervised, unsupervised learning (or other methods of separation that may combine supervised and unsupervised learning), collaborative filtering based profiling or other natural language processing, machine learning operations. It also enables server 330 to act as an expert system to grade the inputted essay in a scale of 1 to 10.

Described below in detail are operations performed at client and server computers to search for content according to a number of embodiments of the present invention. To enable operation of the spell checker, grammar checker, and communication manager program 395 in cooperation with the Web Browser 380, supporting information is provided for which the above-described search/broadcast functions are to be enabled. The Search and Broadcast servers 330 after receiving the HTTP request 360, processes the request and determines the type of operation to be performed (only search, or only broadcast, or both search and broadcast, or other natural language processing operations). Server 330 may also need to fetch content referenced by URI that may have been included in the inputted content by the user. The content referenced by URI may include audio, video, images or text. The referenced content may be fetched using http or ftp or sftp or ssh or other well-known file or content sharing protocols.

It then sends HTTP response 370 of the search results or output from other natural language processing operations to the user computer 300. Server 330 sends forth to the External server 390 if it is posting to public sites 396, and resulting output to 300. The resulting output includes search results, broadcast results, synthesized summary of the inputted text, results of similarity computation, results if the content can be marked as spam if sent via email, results of collaborative filtering if two profiles match, and other natural language processing operations as ordered by the user.

FIG. 4 details an exemplary system that supports the functionality described above and detailed in sections below. The system comprises a client 300 in communication over a network 106 with a server 330, also referred to herein as Search, Broadcast, Natural Language Processing Server. Client 300 can be any processor-based client device capable of communication over a network, for example, a personal computer, a network terminal, a laptop computer, a handheld computer, a PDA, a cellular telephone, and the like, adapted for communicating over a network. In preferred embodiments, client is a computer or mobile device configured for browsing web pages and other content over the internet.

Exemplary client 300 can comprise a central processing unit (CPU) 375, a user interface 310, communications circuitry 418, a memory 420, and a bus 419. Memory 420 can comprise volatile and non-volatile storage units, for example hard disk drives, random-access memory (RAM), read-only memory (ROM), flash memory and the like. In preferred embodiments, memory 420 comprises high-speed RAM for storing system control programs, data, and application programs, comprising programs and data loaded from non-volatile storage. User interface 310 preferably comprises one or more input devices, e.g., keyboard, key pad, soft keys, buttons, wheels, and the like, and a display or other output device. A network interface card or other communication circuitry 418 provides for connection to any wired or wireless communication network 106, which may include the internet and/or any other wide area network, and in particular embodiments comprise a mobile telephone network. Internal bus 419 provides for interconnection of the aforementioned elements of client device 300.

Operation of client 300 is controlled primarily by operating system 422, which is executed by central processing unit 375. Operating system 422 can be stored in system memory 420. In addition to operating system 422, in a typical implementation system memory 420 may include one or more of the following: file system 424 for controlling access to the various files and data structures used by the present invention; an applications module 426, including a web browser 380 for interacting with servers 330 over the internet 106, for example using the Internet Protocol (“IP”) communications protocol, as well as other applications 434, which may include, for example, address book or calendar applications, games, word processing, e-mail, and applications related to telephone features and various other features of client device 300; and an interface engine 430 and a logic engine 432, which may be associated with web browser 380 for customized interaction with web pages as described in more detail herein.

In some embodiments, each of the aforementioned data structures stored or accessible to system in FIG. 4 are single data structures. In other embodiments, such data structures, in fact, comprise a plurality of data structures (e.g., databases, files, archives) that may or may not all be stored on client 300. For example, in some embodiments, data modules 436 comprise a plurality of structured and/or unstructured data records that are stored either on computer 300 and/or on computers that are addressable by computer 300 across the network 106.

Search, Broadcast, Natural Language Processing Server 330 can also be a processor based computer system, comprising of one or multiple CPUs (like Quad Processors) 452, communications circuitry 454 and a memory 456 having similar features and functions as described above with respect to client 300, memory 456 can comprise volatile and non-volatile memory, and can include an operating system 458, a file system 460, data bases 462, and various other application modules, data modules, data structures, and the like. Memory 456 also stores instruction for implementing methods described herein. Various other aspects, details and functions of server 330 are described in sections below.

In particular embodiments, databases 462 of server 330 can include data modules that include codes that specifically may or may not be used for the different HTTP requests of the system in FIG. 4. For example, one particular set of code is used to return the search results of the user request to the client device and described with respect to FIG. 5a, while a different set of code may be used to broadcast user text message to different public posting sites as in FIG. 5b, Moreover, returning search result to the user client along with posting to different public posting sites may require different sets of code on server 330. Similarly, server 330 can include specific sets of code tailored for specific types, brands or models of client devices. Similarly, server 330 can include specific sets of code tailored for specific types of natural language processing methods.

FIGS. 5a and 5b are a block diagram of a system level operation illustrating a functional or client level operation of the user terminal 300 with the Search, Broadcast, Natural Language Processing Server 330 across a data network 106.

The user terminal 300 (personal computer) includes a browser and other client 582 having a graphic user interface (“GUI”) 310 and a Browser—Speller-Grammar Engines 380 that may be an Asynchronous JavaScript and XML (“AJAX”) engine, a HyperText Transfer Protocol (“HTTP”) engine, et cetera. The browser and other clients 582 may be provided by a browser application such as Flock, Firefox, Opera, Safari, Chrome and/or Internet Explorer. For secure transmission, the selected blower client employs SSL protocol or other such secure transmission protocol.

The Search, Broadcast, Natural Language Processing Server 330 includes HyperText Transfer Protocol/eXtensible Markup Language (HTTP/XML) interface module 596, and Search, Broadcast, Natural Language Processing 599. In general, the browser and other clients access the Search and Broadcast server 330, which stores or creates resources such as HyperText Markup Language (“HTML”) files and images. Between the user terminal 300 and the Search and Broadcast server 330 is the data network 106, which as noted earlier, may include several intermediaries, such as proxies, gateways, tunnels et cetera.

The user terminal 300 receives input and provides output via input/output 580 to the browser and other clients 582 through graphic user interface (“GUI”) 310. The Browser/Speller/Grammar Engines 380 receive a multi-line formatted text, and/or multimedia input 586 from the GUI 310. If there are any spellings or other grammatical errors, warning messages (like a red underline for spelling, green underline for possible grammatical errors) are showed immediately on the entered content before the user has submitted the query by pressing enter or clicking on any HyperText Markup Language (“HTML”) form button.

The Browser and Communication engine 380 sends a HTTP request 592 to the Search, Broadcast, Natural Language Processing Server 330 where HTTP is a request/response protocol used for providing a convey to the request across the data network 106. The Browser and other engine 380 uses the HTTP for transmitting HyperText Markup Language (“HTML”) pages across data networks (such as the Internet). HTTP is a request/response protocol for transmitting HyperText Markup Language (“HTML”) search results across data networks 106, such as the Internet, between browser clients and servers. HTTP is defined under IETF Request for Comment (“RFC”) 2616.

The Web/XML interface module 596 receives the HTTP request and passes the Search/broadcast/Natural Language processing request 360. The Search/broadcast/Natural Language processing request 360 is based upon the input of the user via the user terminal 300. Examples of a Search/broadcast/Natural Language processing request 360 include a search query, a broadcast request, and other Natural Language Processing request implicit or explicit.

The Search, Broadcast, Natural Language Processing Software module 599 receives the Search/broadcast request 360 and replies with search, broadcast results and other natural language processing results 602 back to the terminal 300. The Search, Broadcast, Natural Language Processing 599 sends HTTP broadcast 350 to the external server for posting to different public posting sites (5b, 340).

Search, Broadcast, Natural Language Processing 599 provides a search result command to the Web/XML interface module 596. The Web/XML interface module sends a search result web page response 594. The browser engine 380, processes the search result web page response 594, and presents a web page containing the search, broadcast, and other natural language processing results 588 to the GUI 310 for interaction with a user via the user terminal 300.

FIG. 6 illustrates a scrollable two dimensional (2D) search box 600 that includes innumerable data size threshold. The scrollable two dimensional (2D) search box encodes data in multi-line format. As more data is encoded, the scrollbar on the right-hand side of the search box keeps moving in vertically downward direction.

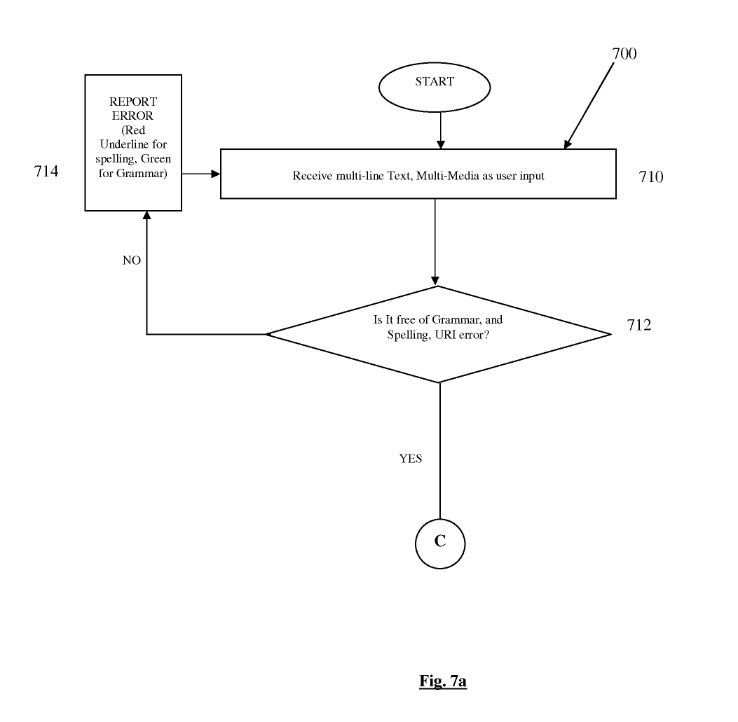

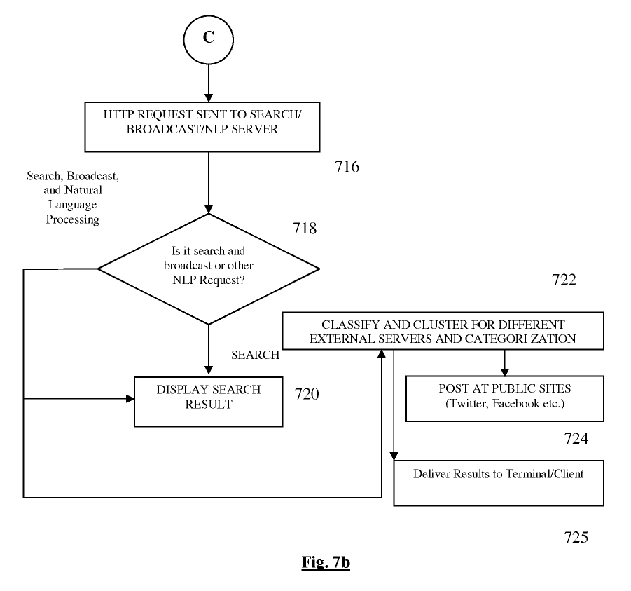

FIGS. 7a and 7b illustrates one embodiment of a flowchart of operations illustrating an exemplary process 700 for generating a module of likely completions for unified search results, user input broadcasting, and other natural language processing on the user input. At block 710, the user enters multi-line text, multimedia input in the bigger scrollable two dimensional (2D) search box. The data originally entered in the search box is analyzed by the client browser and/or related plug-in to determine whether the entered content is grammatically or spelling wise correct 712. It also checks the format, and validity of the entered Universal Resource Locators (URI). It also checks for the existence of the content referenced by the URI. If any error is found, the error is displayed using color coding and error messages 714. If in step 712, there is no error, the browser sends HTTP request (when user press the enter key or click on the submit form button) to search and broadcast server 716. The server processes the request 718 and if it is only a search request, the server retrieves search result and sends back to the user computer for display 720. If the request is to broadcast, the search manager classifies and clusters the user input 722 and finds out which server to broadcast and within the server which category to place the broadcast input and it then sends HTTP broadcast response to the external server for posting to different public posting sites 724. Again, if the request is for both search and broadcast, the server does both the work of search retrieval for display 720 and broadcasting to different public posting sites 724. If the request is for search and other natural language processing functions the server delivers search results, results from the natural language processing like summarized text, similar content and other results 725.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus and method for unified web-search, selective broadcasting, natural language processing utilities, analysis, synthesis, and other applications for text data, image data, audio data, video data, data referenced by Universal Resource Identifier, or a combination thereof, initiated by just one required submit interaction from users comprising:
a central controller including at least one CPU and a memory operatively connected to the CPU;
at least one terminal, adapted for communicating with the central controller, for transmitting to the central controller input information including text data, image data, audio data, video data, data referenced by Universal Resource Identifier, or a combination thereof, special characters to command at least another natural language processing or other utility requests in addition to web or other search;

2. Said terminal according to 1 has an input mechanism to support multi-line input of text data, video data, audio data, image data, and references to other resources via Universal Resource Identifier, or a combination thereof and special characters.

3. Said terminal according to 2 has an input mechanism to support spell and grammar checking, as the user is typing the input.

4. Said terminal according to 3 has an input mechanism to check the validity of the format of a Universal Resource Identifier, and if the referenced content exists as the user is typing the input.

5. Said terminal according to 3 has an input mechanism so that web searchers can express their intentions using paragraphs, interrogative and other grammatical moods, separating input by special characters, special words or text or letters, formatting, style sheets, and Universal Resource Identifier, and can preview it, correcting any spelling or grammatical mistake before submitting for search and other utilities.

6. Said apparatus according to 1 has a memory in the central controller containing a program, adapted to be executed by said CPU, for web or other search of any inputted texts, videos, audios, and images, references to other resources via Universal Resource Identifier, or a combination thereof.

7. Said apparatus according to 1 has a memory in the central controller containing a program, adapted to be executed by said CPU, to see and understand the shifting of ideas across the formatted text, audio, video, or image input (direct or indirect using links or Universal Resource Locator) by analyzing the paragraph demarcations, and starting of sentences of a paragraph, length of paragraphs, and analyzing different attributes of text, image, audio, and video inputs and files to provide various utilities and applications.

8. Said program according to 7 is adapted to be executed by said CPU, for clustering and classification, collaborative filtering based profiling, or other methods of separation (supervised or unsupervised, or combined) of the of inputted texts, videos, audios, and images, references to other resources via Universal Resource Identifier, or a combination thereof.

9. Said program according to 8 is adapted to be executed by said CPU, for web or other search, and simultaneous selective anonymous or non-anonymous broadcast to other CPUs, via a communication network, of inputted texts, videos, audios, and images, references to other resources via Universal Resource Identifier, or a combination thereof, depending on the results from the clustering and classifications.

10. Said program according to 9 is adapted to be executed by said CPU, for web or other search, and simultaneous summarization of inputted texts, videos, audios, and images, references to other resources via Universal Resource Identifier, or a combination thereof.

11. Said program according to 10 is adapted to be executed by said CPU, for extracting, synthesizing different concepts, related concepts from inputted texts, videos, audios, and images, references to other resources via Universal Resource Identifier, or a combination thereof, and enable related web search for those concepts.

12. Said program according to 11 is adapted to be executed by said CPU, for doing statistical similarity (using Euclidean distance, cosine similarity or other similarity measures, different norms in the probability space) checks from inputted texts, videos, audios, and images, references to other resources via Universal Resource Identifier, or a combination thereof separated by special characters, special words or text or letters, and enable related web search for those concepts.

13. Said program according to 12 is adapted to be executed by said CPU, for analyzing input (directly or via Universal Resource Identifier) of a chunk or chunks of text, videos, audios, and images, and one or more questions, and enables finding of answers from inputted texts, videos, audios, and images, references to other resources via Universal Resource Identifier, or a combination thereof, and enable related web search for the input text, videos, audios, and images, or the questions or for both.

14. Said program according to 13 is adapted to be executed by said CPU, for web or other search, and simultaneous parts-of-speech, and entity tagging of inputted texts, videos, audios, and images, references to other resources via Universal Resource Identifier, or a combination thereof.

15. Said program according to 14 is adapted to be executed by said CPU, for web or other search, and simultaneous identification of a text with or without, videos, audios, and images as spam email, and enables related web search for the inputted texts, videos, audios, and images, references to other resources via Universal Resource Identifier, or a combination thereof.

16. A method for unified web-search, selective broadcasting, data-mining utilities, analysis, synthesis, and other applications for text, images, audios and videos, references to other resources via Universal Resource Identifier, or a combination thereof initiated by one or more interaction from users using at least one central controller including at least one CPU and a memory operatively connected to said CPU and containing a program adapted to be executed by said CPU, and a terminal adapted for communicating with said CPU, the method comprising the steps of:
1. Inputting texts, videos, audios, and images references to other resources via Universal Resource Identifier, or a combination thereof to the controller via the terminal;
2. Inputting analysis, synthesis, search criteria to the controller via the terminal;
3. Computing search, broadcast, summarization, similarity checking, clustering, classification, other natural language processing functions, analysis, synthesis, and use of other external applications by having the CPU execute said program; and
4. Outputting the search, analysis, synthesis, and broadcast results to the terminal.
